(19) United States
(12) Patent Application Publication
(10) Pub. No.: US 2009/0170480 A1
(43) Pub. Date: Jul. 2, 2009

(54) Systems and methods for intelligent and customizable communications between devices

(75) Inventor: Michael M. Lee, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/005,821

(22) Filed: Dec. 28, 2007

(51) Int. Cl. H04M 3/42; H04Q 7/20; H04M 1/00

(52) U.S. Cl. 455/414.1; 455/450; 455/566

(57) ABSTRACT

Systems and methods for providing a communications system are provided. The communications system can provide intelligent communications between devices, in which the system can identify appropriate communication modes for incoming communications requests based on a user's preferences and availability. The communications system can determine whether a user is participating in an activity. In response to determining that a user is participating in an activity, the communications system can automatically identify one or more preferred communication modes that are available to the user. In some embodiments of the present invention, the communications system can configure a communications device to send a message back to a contact's device if the communication mode of an incoming communications request is not preferred. The communications system can also allow a user to customize information that is displayed to a subset of the user's contacts.

### BACKGROUND OF THE INVENTION

This invention relates to systems and methods for intelligent and customizable communications between devices.

There are communications devices that allow users to communicate with each other in one or more modes. For example, these devices can allow users to communicate via voice communications (e.g., telephonic communications and voicemails), e-mails, and SMS text messaging. Some communications devices can be loaded with instant messaging applications, such as iChat™ available by Apple Inc. of Cupertino, Calif. These applications can allow users to send real-time communications requests (e.g., text, audio, and/or video) to each other.

Some instant messaging applications can automatically determine the state of a user and inform the user's instant messaging contacts of that state. For example, when the user logs on to the instant messaging application, the application may automatically set the state of the user to the “available” state. Then, the instant messaging application may automatically notify the user's instant messaging contacts of this “available” state if and when the user's contacts log onto the instant messaging network. However, in some cases, the user may prefer to communicate with only a subset of his instant messaging contacts and may not want to be bothered by the remaining contacts.

In addition, when a contact sends the user a communications request, some communications devices may notify the user of the incoming communications request, regardless of whether it may be appropriate or desirable to disturb the user. For example, when the user is at a meeting and forgets to set the communications device to vibrate, an incoming communications request may disrupt the meeting. As another example, the user may be in a gym and may prefer not to be interrupted by anyone except his family. If the user's boss calls, the communications device would immediately notify the user of the call. As a result, the user has to look to see who is calling, which interrupts his workout. In addition, if the user chooses to ignore the call, his boss is left wondering why the user is unable to answer the call.

Accordingly, what is needed are systems and methods for intelligent communications between devices, in which the system can select appropriate communication modes for incoming communications requests based on a user's preferences and availability. What is also needed are systems and methods for enabling a user to provide customized information for his contacts.

### SUMMARY OF THE INVENTION

In accordance with the present invention, a communications device and method of operation are provided in which the device can select appropriate communication modes for incoming communications requests based on a user's preferences and availability. In addition, the communications device can determine the communication modes of a user based on the current activity and allow the user to provide customized information to his contacts.

In some embodiments of the invention, one or more categories of data can be collected to determine if a user is participating in an activity. For example, the communications device can be operative to receive sensor data, which can include location data, environment data, and exercise data. As another example, the communications device can be operative to receive device data, which can include usage data, calendar data, and news data. In some embodiments, the communications device can determine the preferred communication modes (e.g., telephonic communications, voicemail, text messaging, instant messaging, and e-mail) based on the collected data.

In some embodiments, the communications device can resolve conflicting communication modes. For example, based on exercise data, the communications device may determine that the preferred communication mode is voicemail. However, based on calendar data, the communications device may determine that the preferred communication modes are instant messaging and e-mail. In some embodiments, the conflicts can be resolved by user selection. In some embodiments, the communications device can resolve conflicts based on a priority order established for the categories of data or the communication modes.

In some embodiments, the user can provide customized information (e.g., state, icon, message, and communication modes) for display to a subset of the user's contacts. The subset of the user's contact can include individual contacts and contact groups. For example, the user can choose to display an “Available” state to a family group and display an “Away” state to a work group. In some embodiments, the communications device can automatically create a rest-of-contacts group that can include contacts that have not been configured to receive customized information.

In some embodiments, the communications device can be operative to receive an incoming communications request from a contact, and can determine the communication mode of the incoming communications request. If it is determined that the communication mode is one of the preferred modes for the contact, the communications device may notify the user of the incoming communications request. If it is determined that the communication mode is not one of the preferred modes for the contact, the communications device may not notify the user of the incoming communications request. In addition, the communications device can send the preferred communication modes to the contact's device. In some embodiments, if the communications device detects that the user is currently participating in an activity, the communications device can send a message to the contact's device that includes information about the activity.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a simplified diagram of a communications device which may be used in accordance with one embodiment of the present invention;

FIG. 2 shows a simplified block diagram of a communications device in accordance with an embodiment of the present invention;

FIG. 3 shows a schematic view of a communications system in accordance with one embodiment of the invention;

FIG. 4 shows a schematic view of an illustrative home screen of a communications device in accordance with one embodiment of the invention;

FIG. 5 shows a schematic view of an illustrative display screen of an instant messaging application in accordance with one embodiment of the invention;

FIG. 6 shows a schematic view of an illustrative display screen for changing settings in accordance with one embodiment of the invention;

FIG. 7 shows a schematic view of an illustrative display screen for providing basic information in accordance with one embodiment of the invention;

FIG. 8 shows a schematic view of an illustrative display screen for determining preferred communication modes in accordance with one embodiment of the invention;

FIG. 9 shows a schematic view of an illustrative display screen for automatically determining preferred communication modes in accordance with one embodiment of the invention;

FIG. 10 shows a schematic view of an illustrative display screen for providing customized information in accordance with one embodiment of the invention;

FIG. 11 shows a schematic view of an illustrative display screen for providing options for changing the communications profile of a subset of the user's contacts in accordance with one embodiment of the invention;

FIG. 12 shows a schematic view of an illustrative display screen for displaying a message with recommendations of preferred communication modes in accordance with one embodiment of the invention;

FIGS. 13A-13D show flowcharts of an illustrative process for changing settings in accordance with one embodiment of the invention; and

FIG. 14 shows a flowchart of an illustrative process for processing incoming communications requests in accordance with one embodiment of the invention.

### DETAILED DESCRIPTION OF THE INVENTION

Conventional communications devices can provide users with one or more communication modes (e.g., voice communications, e-mails, SMS text messaging, and instant messaging applications). However, these devices do not consider a user's preferences while handling communications requests. For example, a conventional communications device can be loaded with an instant messaging application, which can display a user's state to his instant messaging contacts. However, the user may not want all of his instant messaging contacts to see the same state, or even be able to communicate with him in the same way.

In addition, these conventional communications devices may notify the user of all incoming communications requests, regardless of whether it may be appropriate or desirable to disturb the user.

The present invention can include a communications system for providing intelligent communications between devices. The communications system can select appropriate communication modes for incoming communications requests based on a user's preferences and availability. The communications system can determine if a user is participating in an activity, identify the communication modes that are available for the user based on the activity, and notify a contact's device of the identified communication modes. The system also can allow the user to assign customizable information (e.g., communication modes) for display to his contacts.

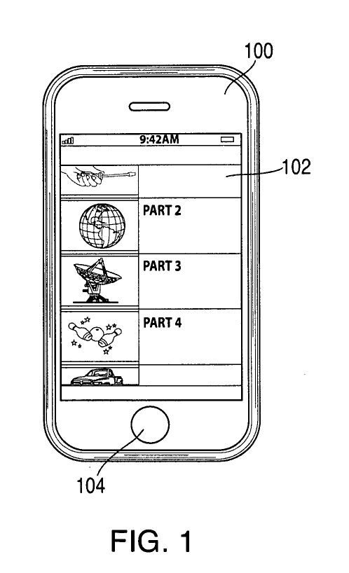

FIG. 1 shows a simplified diagram of a communications device which may be used in accordance with one embodiment of the present invention. Persons skilled in the art will appreciate that one or more elements of the described embodiments can be interchanged and/or combined in the present invention. Communications device 100 can be, for example, a portable media player, cellular telephone, internet-capable device, personal organizer, any other communications device, or any combination thereof. In one embodiment of the present invention, communications device 102 can be an iPhone™ sold by Apple Inc.

Communications device 100 can incorporate user interface component 102. User interface component 102 is shown in FIG. 1 as a multi-touch screen that may function as both an integrated display screen and user input device. Some embodiments of multi-touch screens are discussed in more detail in commonly assigned Westerman et al., U.S. Pat. No. 6,323,846, issued Nov. 27, 2001, entitled “Method and Apparatus for Integrating Manual Input,” which is incorporated by reference herein in its entirety.

While FIG. 1 illustrates user interface component 102 as being integrated into communications device 100, it also can be disposed external to communications device 100 and coupled thereto. For example, user interface component 102 can be a computer monitor, television screen, and/or any other graphical user interface, textual user interface, or combination thereof. User interface component 102 can enable communications device 100 to playback the video portion of video content, display command menus, and/or serve any other suitable display function.

Communications device 100 can also include button 104, which can be used in conjunction with user interface component 102. Button 104 can be used, for example, to turn on user interface component 102 or return to a display screen on user interface component 102 (e.g., a home screen).

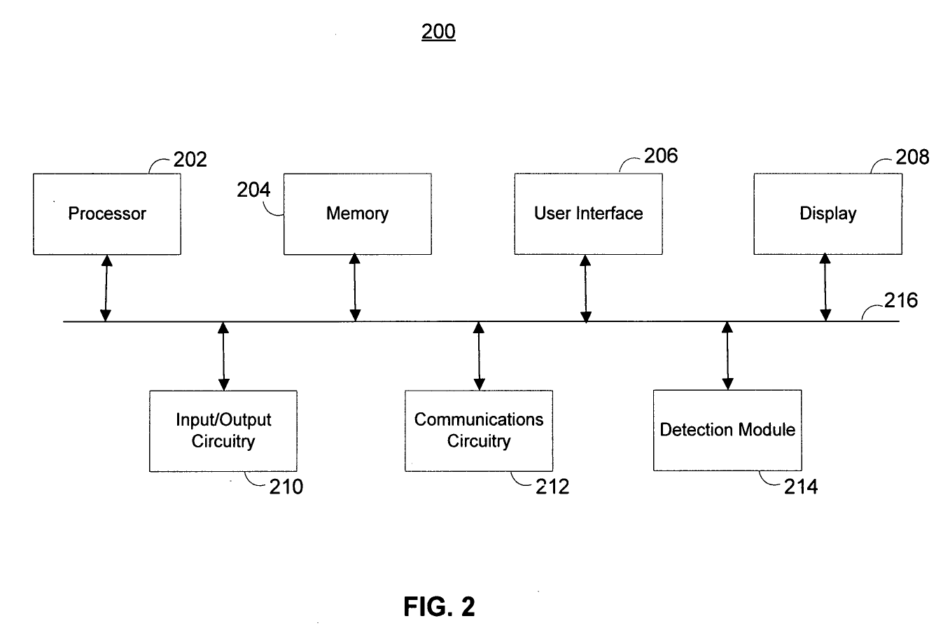

FIG. 2 shows a simplified block diagram of a communications device in accordance with an embodiment of the present invention. Communications device 200 can include processor 202, memory 204, user interface 206, display 208, input/output circuitry 210, communications circuitry 212, detection module 214, and/or bus 216. In some embodiments, communications device 200 can include more than one of each component or circuitry, but for the sake of illustration, only one of each is shown in FIG. 2. In addition, persons skilled in the art will appreciate that the functionality of certain components and circuitry can be combined or omitted and that additional components and circuitry, which are not shown in FIG. 2, can be included in communications device 200. Persons skilled in the art will also appreciate that all of the components can be integrated into communications device 300, or one or more of the components can be provided externally or remotely. Communications device 200 can be a computer, cellular phone, portable media device or other similar device without departing from the spirit of the present invention.

Processor 202 can include, for example, circuitry for and be configured to perform any function. Processor 202 can be used to run operating system applications, instant messaging applications, phone applications, e-mail applications, text messaging applications, media playback applications, media editing applications, calendar applications, and/or any other applications. Processor 202 can drive display 208 and can receive user inputs from user interface 206. In some embodiments, processor 202 can be operative to change certain functions of the communications device when communications device is coupled to external components. For example, if Nike+ sensors are installed on the user's shoes, an external receiver or communications circuitry 212 can transmit information received from the sensors to processor 202. Processor 202 can be configured to run a Nike+ workout feature and send details of the workout as display signals to display 208. If processor 202 determines that a user is jogging with the Nike+ workout feature and using a media playback application (e.g., iPod application made available by Apple Inc.), processor 202 can generate a music playlist based on the time, pace, and distance of the workout.

Memory 204 can include one or more different types of memory or storage mediums which can be used for performing device functions. For example, memory 210 can include cache, Flash, ROM, RAM, one or more different types of memory used for temporarily storing data, a hard-drive, tape drive, optical drive, permanent memory such as ROM, semi-permanent memory such as RAM, cache, any other suitable type of memory component, or any combination thereof. Memory 204 can be specifically dedicated to storing firmware. For example, memory 204 can be provided for storing firmware for device applications (e.g., operating system, user interface functions, and processor functions). Memory 204 can be used to store any suitable user-specific or global information that can be used by communications device 200. Memory 204 can store, for example, media data (e.g., music and video files), application data (e.g., for implementing functions on device 200), preference information data (e.g., media playback preferences), lifestyle information data (e.g., food preferences), exercise information data (e.g., information obtained by exercise monitoring equipment), transaction information data (e.g., information such as credit card information), wireless connection information data (e.g., information that may enable device 200 to establish a wireless connection), subscription information data (e.g., information that keeps track of podcasts or television shows or other media a user subscribes to), contact information data (e.g., telephone numbers and e-mail addresses), calendar information data, any other suitable data, or any combination thereof. Memory 204 can store programs or applications that can be run on processor 202, can maintain files formatted to be read and edited by one or more of the applications, and can store any additional files that may aid the operation of one or more applications (e.g., files with metadata).

With continuing reference to FIG. 2, communications device 200 can include user interface 206 and display 208 for providing a user with the ability to interact with communications device 200 (e.g., an application running on processor 202). User interface 206 can take a variety of forms, such as a keyboard/keypad, computer mouse, clickwheel/scrollwheel, button, or touchscreen. User interface 206 can also include an audio input device (e.g., a microphone) or a video input device (e.g., a camera or a web cam) for recording. Display 208 can include a liquid crystal display (LCD) or any other suitable display system for presenting information or media to a user. In some embodiments, display 208 can be controlled by graphics circuitry. The graphics circuitry can include a video card, such as a video card with 2D or 3D capabilities. In some embodiments, display 208 and user interface 206 can be combined into one component in, for example, a multi-touch interface or a touchscreen display.

In some embodiments, display 208 can include a coder/decoder (CODEC) to convert digital media data into analog signals. Display 208 also can include display driver circuitry and/or circuitry for driving display driver(s). Processor 202 or display 208 can generate the display signals. The display signals can provide media information related to media data received from communications circuitry 212 and/or any other component of communications device 200. In some embodiments, display 208, like any other component discussed herein, can be integrated with and/or externally coupled to communications device 200.

Input/output circuitry 210 can convert (and encode/decode, if necessary) data, analog signals and other signals (e.g., physical contact inputs, physical movements, analog audio signals, etc.) into digital data, and vice-versa. The digital data can be provided to and received from processor 202, memory 204, or any other component of communications device 200. Although input/output circuitry 210 is illustrated in FIG. 2 as a single component of communications device 200, a plurality of input/output circuitry may be included in communications device 200. Input/output circuitry 210 may be used to interface with any input or output component, such as those discussed in connection with FIG. 1. For example, communications device 200 can include specialized input circuitry associated with input devices such as, for example, proximity sensors, accelerometers, or ambient light detectors. Communications device 200 can also include specialized output circuitry associated with output devices such as, for example, one or more speakers.

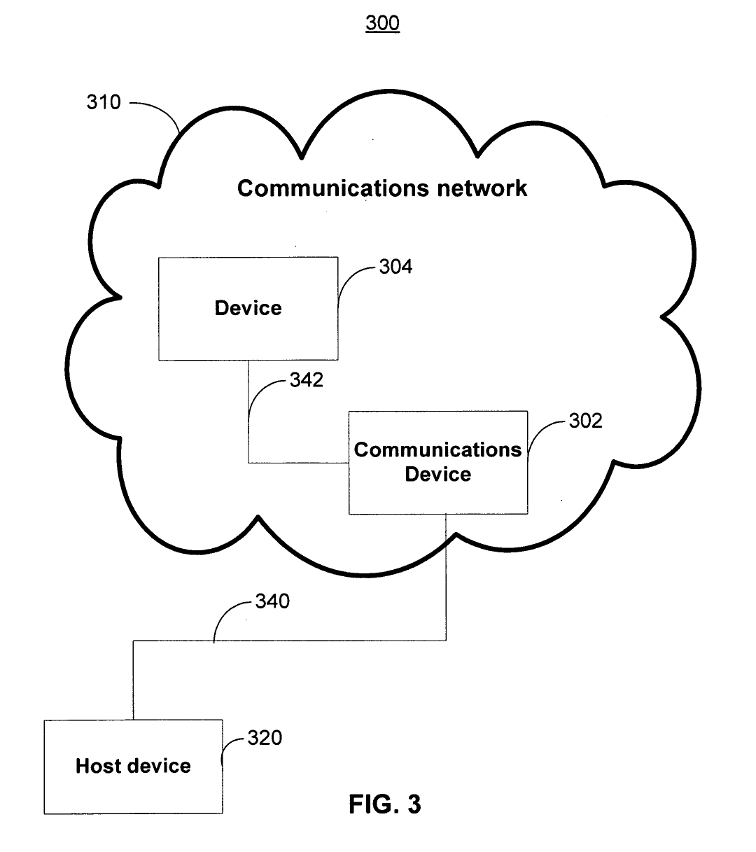

Communications circuitry 212 can permit communications device 200 to communicate with one or more servers, components, or other devices using any suitable communications protocol. For example, communications circuitry 212 can support Wi-Fi (e.g., a 802.11 protocol), Ethernet, Bluetooth™ (which is a trademark owned by Bluetooth Sig, Inc.), high frequency systems (e.g., 900 MHz, 2.4 GHz, and 5.6 GHz communications systems), infrared, TCP/IP (e.g., any of the protocols used in each of the TCP/IP layers), HTTP, BitTorrent, FTP, RTP, RTSP, SSH, any other communications protocol, or any combination thereof. In some embodiments, communications circuitry 212 may include a wired or wireless network interface card (“NIC”) configured to connect to the Internet or any other public or private network. Communications circuitry 212 can be used to initiate and conduct communications with other communications devices or media players or systems within a communications network. Communications networks will be discussed in more detail in FIG. 3.

Detection module 214 can include any suitable type of technology that may detect activities of a user. For example, an activity that may be detected in accordance with the invention can include, but is not limited to, any location-based activity (e.g., the device entering or exiting a specific geographical location, such as a country, or a specific type of location, such as a movie theater), any environment-based activity (e.g., the device being subjected to a specific physical orientation, movement, temperature, sound, and light), any Nike+ activity (e.g., the device receiving information that the user is working out using the Nike+ feature), any calendar-based activity (e.g., the device reaching a specific time of day, day of week, and date), any usage-based activity (e.g., the device being used for a specific function, for a specific period of time, the device's battery having less than half of its capacity remaining), any news-based activity (e.g., the device receiving information about a particular worldly occurrence, such as a weather forecast, news report, or sport score), and combinations thereof. In some embodiments, certain activities can be detected by one or more sensors, such as a location sensor (e.g., GPS and a RF triangulation sensor or detector), an environment sensor (e.g., temperature sensor, light sensor, motion sensor, orientation sensor, distance sensor, pressure sensor, or sound sensor), a Nike+ sensor, any other suitable sensors, or any combination thereof.

In some embodiments, the detection module can compute one or more categories of data, which can include different types of data (e.g., location data, environment data, Nike+ data, calendar data, usage data, news-based data). Although detection module 214 can be implemented in software in some embodiments, detection module 214 can also be implemented in hardware, firmware, or any combination thereof. For example, detection module 214 can include an application process configured to compute the one or more categories of data with respect to communications device 200. Detection modules are discussed in more detail in Lee, U.S. patent application Ser. No. ______ (Attorney Docket No. 104677-0054), filed Oct. 10, 2007, entitled “Location-Based Modes for Portable Media Devices,” the entirety of which is incorporated herein by reference.

Bus 216 can provide a data transfer path for transferring data to, from, or between processor 202, memory 204, user interface 206, display 208, input/output circuitry 210, communications circuitry 212, and detection module 214. Persons skilled in the art will appreciate that components do not have to be directly connected to each other via bus 216.

Communications device 200 can be implemented in or as any type of electronic device or devices, such as, for example a desktop computer, a laptop computer, or communications device 102 (FIG. 1). For example, communications device 200 can include a user communications device, such as a desktop computer (e.g., an iMac available from Apple Inc) or a laptop computer (e.g., a PowerBook or MacBook available from Apple Inc).

As another example, communications device 200 can be a portable device dedicated to providing media processing and telephone functionality in a single integrated unit (e.g., iPhone™ available from Apple Inc). Communications device 200 can be battery-operated and highly portable so as to allow a user to listen to music, play games or video, record video or take pictures, place and take telephone calls, communicate with other people or devices, control other devices, and any combination thereof. In addition, communications device 200 can be sized such that it fits relatively easily into a pocket or hand of the user. By being handheld, communications device 200 is relatively small and easily handled and utilized by its user and thus can be taken practically anywhere the user travels.

FIG. 3 shows a schematic view of a communications system in accordance with one embodiment of the invention. Communications system 300 can include communications device 302 and communications network 310, which communications device 302 can use to perform communications with other devices within communications network 310 (e.g., device 304). Although communications system 300 can include several communications devices 302, devices 304, and host devices 320, only one of each is shown in FIG. 3 to avoid overcomplicating the drawing.

In some embodiments, communications device 302 or device 304 can be coupled to host device 320 for data transfers, synching the communications device, software or firmware updates, or performing any other suitable operation that can require communications device 302 and host device 320 to be coupled. In some embodiments, several communications devices 302 can be coupled to host 320 to share data using host 320 as a server. In some embodiments, communications device 302 can be coupled to several host devices 320 (e.g., for each of the plurality of host devices 320 to serve as a backup for data stored in communications device 302).

Communications device 302 can be coupled with host device 320 over communications link 340 using any suitable approach. For example, communications device 302 can use any suitable wireless communications protocol to connect to host device 320 over communications link 340. As another example, communications link 340 can be a wired link that is coupled to both communications device 302 and host device 320. As still another example, communications link 340 can include a combination of wired and wireless links (e.g., an accessory device for wirelessly communicating with communications device 302 is coupled by a wire to host device 320). Any suitable connector, dongle or docking station can be used to couple communications device 302 and host device 320. A more detailed discussion of a dongle or docking station that can be plugged into communications device 302 can be found, for example, in Fadell et al., U.S. patent application publication No. 2004-0224638 (Attorney Docket No. ______), filed Apr. 25, 2003, entitled “Media Player System,” which is incorporated by reference in its entirety herein.

Any suitable circuitry, device, system or combination of these (e.g., a wireless communications infrastructure including communications towers and telecommunications servers) operative to create a communications network can be used to create communications network 310. Communications network 310 can be capable of providing wireless communications using any suitable short-range or long-range communications protocol. In some embodiments, communications network 310 can support, for example, Wi-Fi (e.g., a 802.11 protocol), Bluetooth (registered trademark), high frequency systems (e.g., 900 MHz, 2.4 GHz, and 5.6 GHz communications systems), infrared, other relatively localized wireless communications protocol, or any combination thereof. In some embodiments, communications network 310 can support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Communications device 302 and device 304, when located within communications network 310, can wirelessly communicate over a local wireless communications path such as path 342.

Communications device 302 and device 304 can be any suitable device for sending and receiving communications. For example, communications device 302 and device 304 can include a media player such as an iPod™ available by Apple Inc., of Cupertino, Calif., a cellular telephone, a personal e-mail or messaging device (e.g., a Blackberry® or a Sidekick®), an iPhone™ available from Apple Inc., pocket-sized personal computers such as an iPAQ Pocket PC available by Hewlett Packard Inc., of Palo Alto, Calif., personal digital assistants (PDAs), a desktop computer, a laptop computer, and any other device capable of communicating wirelessly (with or without the aid of a wireless enabling accessory system). The communications sent and received can be any suitable form of communications, including for example, voice communications (e.g., telephonic communications), data communications (e.g., e-mails, text messages, media messages), or combinations of these.

In some embodiments, users can send and receive data communications using an instant messaging application (e.g., iChat™ available by Apple Inc.) that is stored on communications device 302. The instant messaging application can allow users to communicate with each other in real-time using text, audio, and/or video.

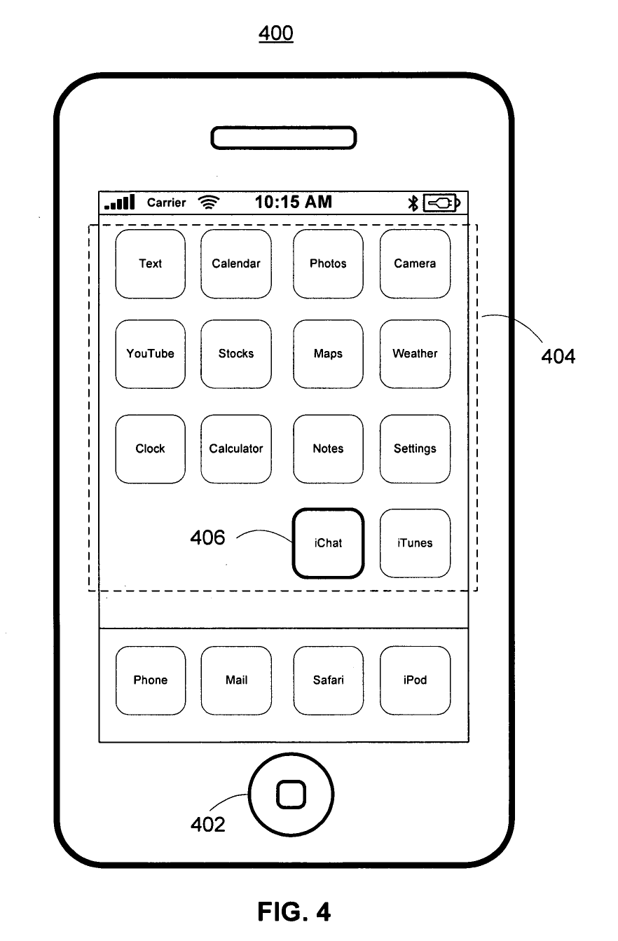

FIG. 4 shows a schematic view of an illustrative home screen of a communications device in accordance with one embodiment of the invention. Display screen 400 can include icons 404 representing applications that a communications device, such as communications device 200 (FIG. 2), can execute. The applications can include text, calendar, photos, camera, phone, mail, instant messaging, or any other suitable application. Display screen 400 can be displayed on a display, such as display 208 (FIG. 2), when the communications device is first turned on or when the communications device has exited out of an application that was running. Display screen 400 can also be displayed when a user presses button 402 while the communications device is still running an application.

The user may select an application by selecting the associated icon (e.g., icon 406). Communications device 400 can visually distinguish the desired icon from the remaining icons by, for example, intensifying the colors of the icon or placing a highlight region over the icon. In some embodiments, in response to receiving a user selection of an instant messaging application (e.g., iChat), a processor, such as processor 202 (FIG. 2), may be configured to run the instant messaging application. The instant messaging application may be provided by a program stored in memory, such as memory 210 (FIG. 2), and may allow the user to, among other things, send real-time communications requests to his contacts. In some embodiments, the instant messaging application may require the user to enter a username and password to log in to the application. In some embodiments, the communications device can automatically log the user in to the application. For example, the user may have previously stored his username and password on the communications device (e.g., the username and password may be stored in memory 204).

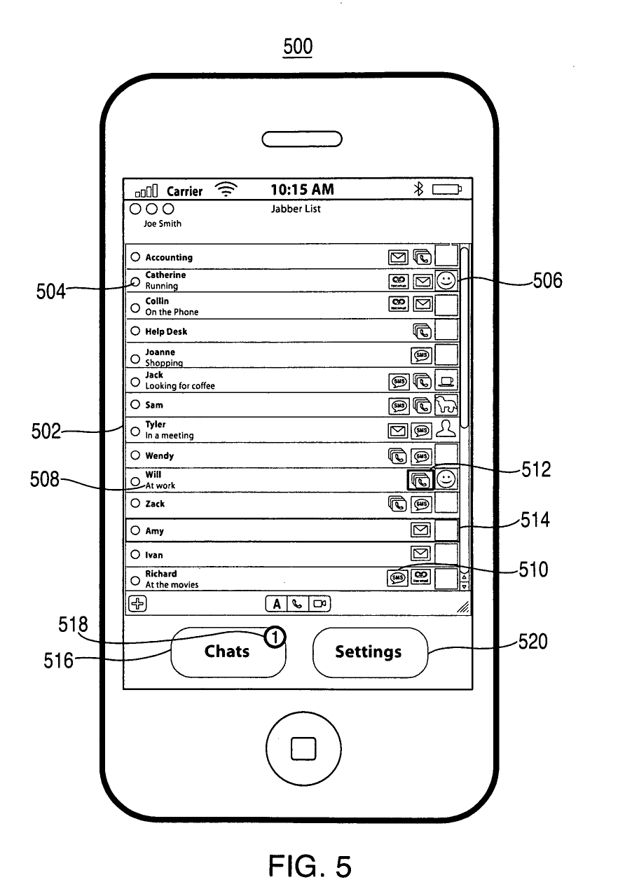

FIG. 5 shows a schematic view of an illustrative display screen of an instant messaging application in accordance with one embodiment of the invention. Display screen 500 may include contact listings 502, which may provide the user with names and real-time information regarding contacts who subscribe to the same instant messaging network as the user. In some embodiments, the communications device may automatically set or allow contacts to set four states: “available,” “away,” “idle,” and “offline”. For example, if a contact is currently available to communicate, the contact's state may appear as “available.” If the contact is currently busy and prefers not to be disturbed, the contact's state may appear as “away.” If the contact has been idle for a period of time or would like to appear to be idle, the contact's state may appear as “idle.” If the contact is offline, such as, for example, when the contact logs out of the instant messaging network or turns off the communications device, the contact's state may appear as “offline.” In some embodiments, the contact may also set his state to “offline,” for example, if he prefers not to have his state revealed to others. Although embodiments of the present invention will generally be described in terms of these four states, it should be understood that any other suitable state (e.g., an “invisible” state where a contact may appear to be invisible but may still monitor the states of other people) may be provided by the communications device.

In some embodiments, contact listings 502 can display the states of the user's contacts as states 504. For example, state 504 can appear as a green, red or yellow dot depending on whether the state of a contact is “available,” “away,” or “idle,” respectively. In some embodiments, if the state of a contact is “offline,” state 504 may not be displayed. It may be understood that any other suitable type of graphics may be used to demonstrate the state of the user's contacts. Graphics can include, for example, images, animations, videos, text, or any combination thereof.

In some embodiments, contact listings 502 may include icons 506, which may be a still or animated image that has been selected by the contact. For example, the contact or the user may customize icon 506 to display a picture of the contact or display an animated cartoon.

In some embodiments, contact listings 502 can include messages 508, which can be text that has been automatically generated by the contact's device or created by the contact. For example, the contact's device can automatically generate a default away message such as “Away.” In some embodiments, the contact may create and store one or more messages for each state. For example, the contact may create multiple available messages, away messages, idle messages, and offline messages.

In some embodiments, contact listings 502 can include mode indicators 510, which can represent the preferred and/or available communication modes for the user's contacts. For example, mode indicators 510 can indicate that a contact can be reached using telephonic communications, voicemails, text messages, instant messages, e-mails, any other suitable communication modes, or any combination thereof. For example, when a contact's state is “away” and the contact's mode indicator is set to telephonic communications, the contact is indicating to the user that he prefers to be contacted by phone. In some embodiments, mode indicators 510 can be listed in an order that is ranked according to the contact's preferences. For example, the first mode indicator listed can represent the most preferred communication mode, and the last mode indicator listed can represent the least preferred communication mode. In some embodiments, representations of unavailable communication modes may not be displayed or may be greyed out. For example, even if a user prefers to be contacted via a particular communication mode (e.g., by phone), the communications device may not display this if either the user's or the contact's communications device can not connect to an appropriate communications line (e.g., lacks a sufficiently strong cellular signal). It may be understood that the communications device can use any other suitable method of demonstrating the desirability and availability of various communication modes.

In some embodiments, a user may be able to initiate a communications request to a contact using one of the contact's preferred communication modes by selecting the appropriate mode indicator 510. For example, the user may select a mode indicator by placing highlight region 512 thereover. In response to the user selecting a mode indicator, the processor may proceed to communicate with the contact using the communication mode represented by the mode indicator. For example, if the user selects a phone mode indicator for a contact, the processor may initiate a telephone call with the selected contact. As another example, if the user selects an e-mail mode indicator for a contact, the processor may launch an e-mail application and display a new e-mail window addressed to the selected contact. As yet another example, if the user selects a text messaging mode indicator for a contact, the processor may launch a text messaging application and display a text messaging window that the user may use to text message the selected contact.

In some embodiments, when the user selects a listing by placing highlight region 514 over contact listings 502, the communications device can allow the user to communicate with a contact in real-time using text (e.g., SMS text messaging), audio, and/or video. For example, the user may see an instant messaging window where the user may type a message to the selected contact. In some embodiments, if the user's communications device and the contact's device both include audio input devices (e.g., microphones) or video input devices (e.g., cameras or web cams), the user may initiate an audio or video chat with the contact. For example, the user may see a window with a video of the contact. The user may use the window to communicate in real-time with the contact. In some embodiments, instead of selecting contact listings 502, the user may select a video icon to initiate a video communications with a contact.

In some embodiments, display screen 500 may include “CHAT” option 516, which the user may select to display all active or previously active instant messaging windows. In some embodiments, display screen 500 may include new chat icon 518, which may appear if any new chats were initiated by a contact in contact listings 502. The user may select “CHAT” option 516 to see the new chat.

Although the discussion above regarding the selection and display of information (e.g., states, icons, messages, mode indicators) was described in terms of contacts listed in contact listings 502, the user may also select and display similar information about himself. In some embodiments, in response to the user selecting “SETTINGS” option 520, the communications device may allow the user to set information that may be displayed to the user's contacts.

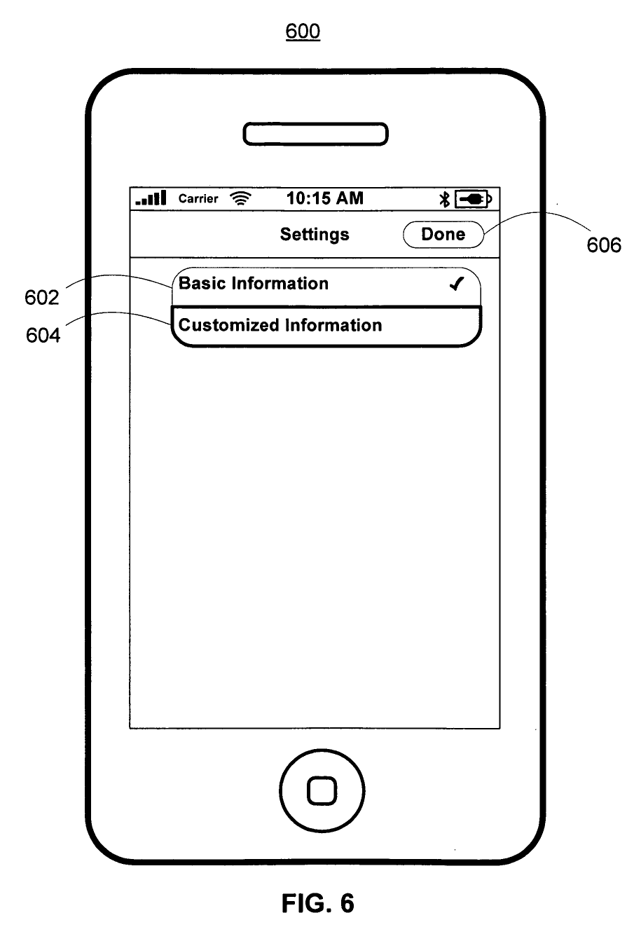

FIG. 6 shows a schematic view of an illustrative display screen for changing settings in accordance with one embodiment of the invention. In the embodiment of FIG. 6, for example, several options for changing the setting of the user's information are shown. However, it may be understood that similar options may be displayed for other aspects of the user's settings, such as video settings, audio settings, layout settings, and SMS forwarding settings.

In some embodiments, display screen 600 can include “BASIC INFORMATION” option 602, which may be used to configure information that can be globally displayed to the user's contacts. For example, when the user updates his state to “available” using “BASIC INFORMATION” option 602, all of the contacts listed in contact listings 502 may observe that the state of the user is “available” (FIG. 5).

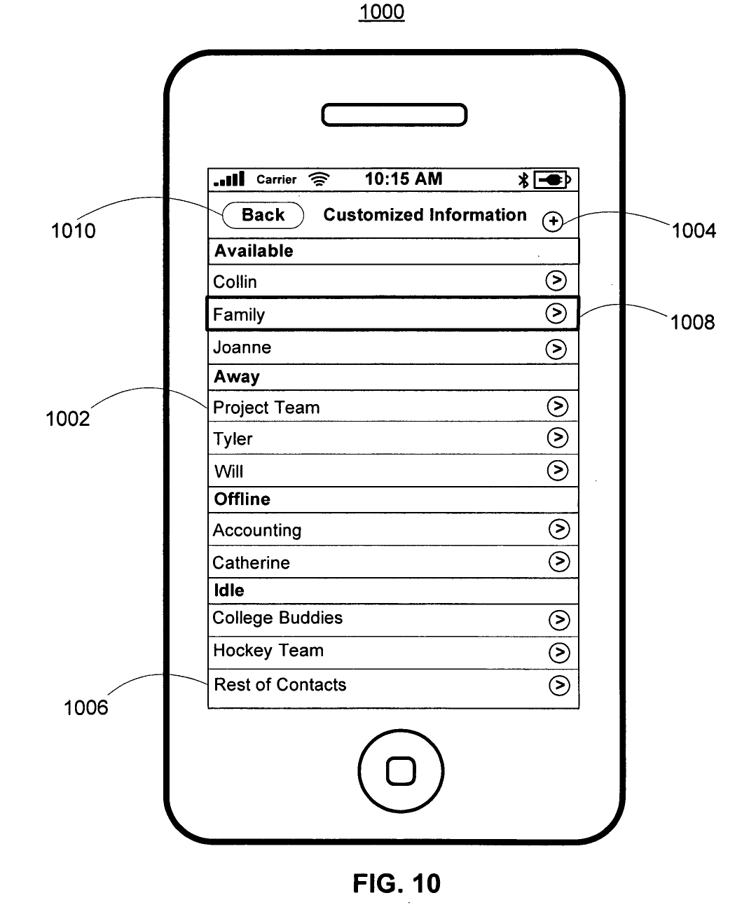

In some embodiments, display screen 600 can include “CUSTOMIZED INFORMATION” option 604, which can allow the communications device to customize the display of the user's information for subsets of contacts (e.g., individual contacts or groups of contacts) in contact listings 502 (FIG. 5). For example, the user may want to appear “away” to his boss and “available” to everyone else on his contact list. In response to the user selecting “CUSTOMIZED INFORMATION” option 604, the communications device can provide options for the user to customize the information displayed to subsets of contacts. A more detailed description of “CUSTOMIZED INFORMATION” option 604 is provided in FIG. 10.

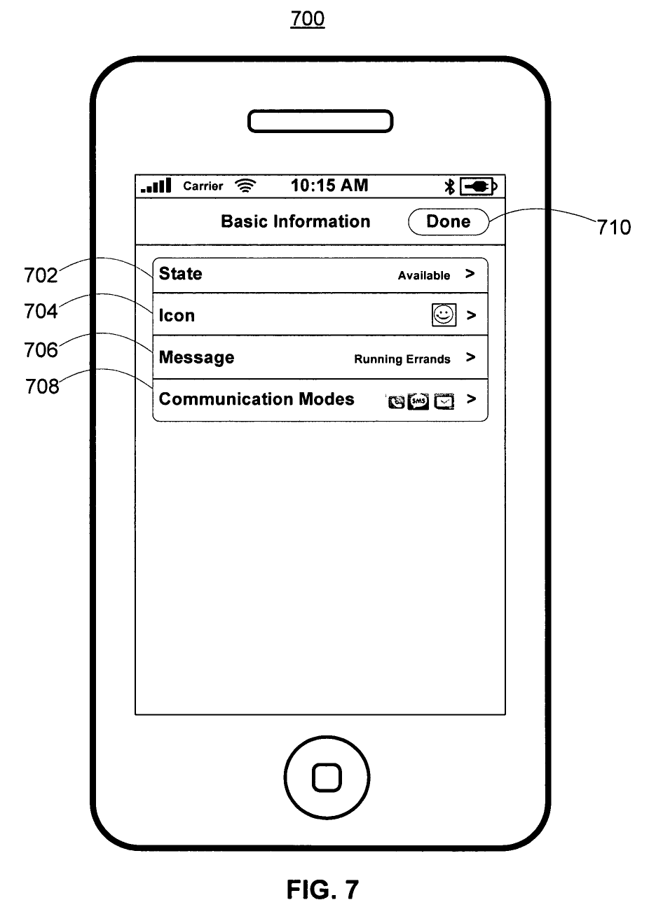

FIG. 7 shows a schematic view of an illustrative display screen for providing basic information in accordance with one embodiment of the invention. Display screen 700 can include “STATE” option 702. In response to a user selecting “STATE” option 702, the communications device can provide the user with “STATE” options (e.g., “available,” “away,” “idle,” and “offline”) that can be displayed to the user's contacts.

In some embodiments, display screen 700 can include “ICON” option 704. In response to a user selecting “ICON” option 704, the communications device can provide the user with an option to change the icon displayed to the user's contacts. For example, the user may use a picture stored on the communications device or an image downloaded from the web. As another example, the user may create a customized picture using a clipart application.

In some embodiments, display screen 700 can include “MESSAGE” option 706. In response to a user selecting “MESSAGE” option 706, the communications device can provide the user with an option to create a customized message for the user's contacts. In some embodiments, the communications device can allow the user to store the new information in memory, such as memory 204 (FIG. 2). After the user stores the information, the user may reload the information at a future time without having to input the information again.

In some embodiments, display screen 700 can include “COMMUNICATION MODES” option 708. In response to a user selecting “COMMUNICATION MODES” option 708, the communications device can provide the user with options for determining preferred communication modes.

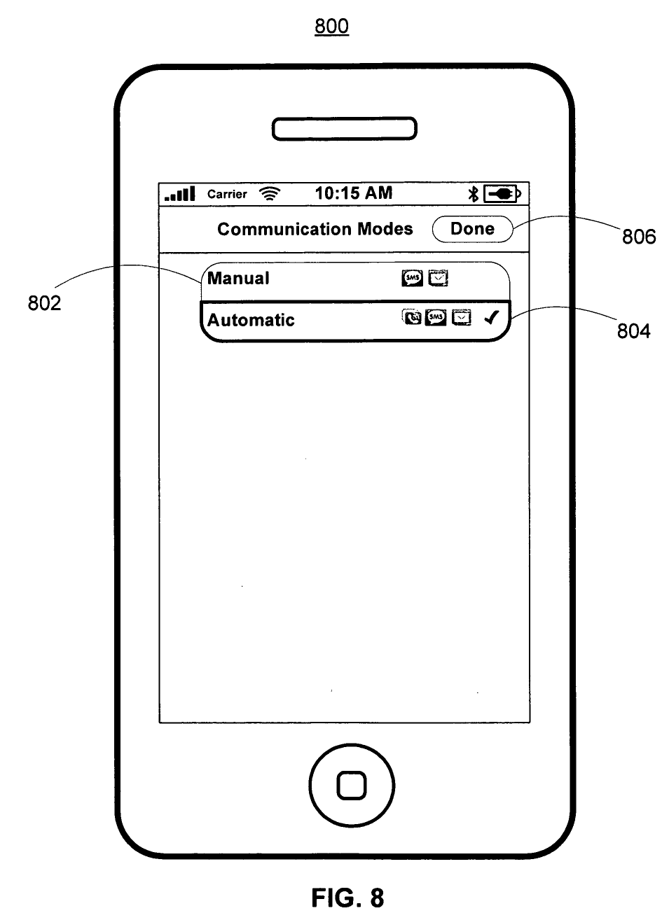

FIG. 8 shows a schematic view of an illustrative display screen for determining preferred communication modes in accordance with one embodiment of the invention. In some embodiments, display screen 800 can include “MANUAL” option 802, which can allow the user to manually select preferred communication modes, or “AUTOMATIC” option 804, which can allow the communications device to automatically determine the user's preferred communication modes.

When a user selects “MANUAL” option 802, the communications device can provide the user with various mode indicators representing communication modes (e.g., telephonic communications, voicemails, text messages, instant messages, and e-mails). The user may select any combination of mode indicators and may place the selected mode indicators in an order based on user preference. The selected mode indicators can be displayed to the user's contacts in real-time.

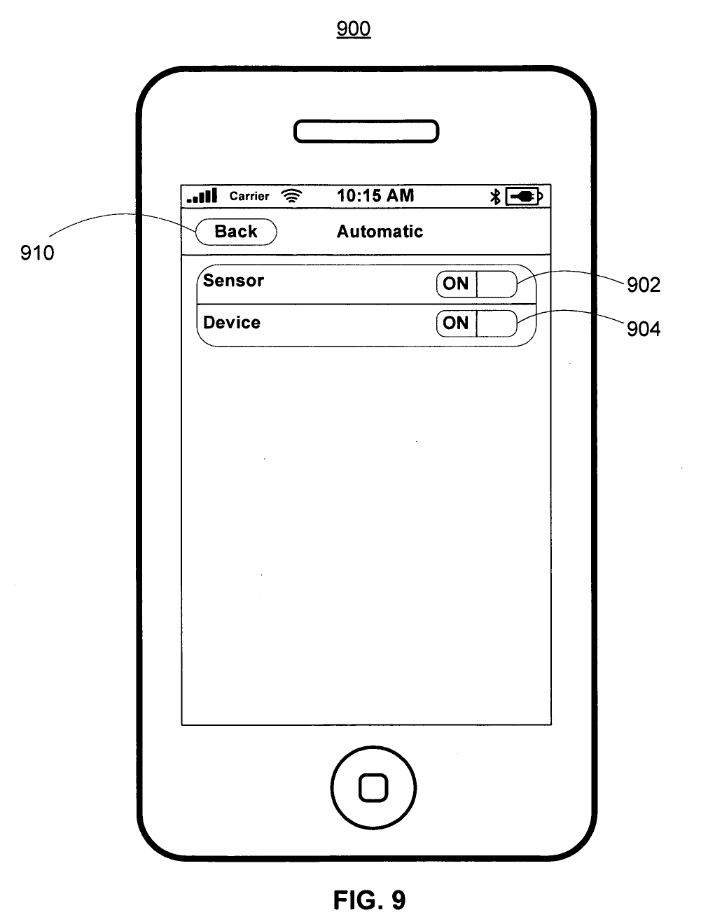

FIG. 9 shows a schematic view of an illustrative display screen for automatically determining preferred communication modes in accordance with one embodiment of the invention. By detecting current user activities, the communications device can determine the user's preferred communication modes. In some embodiments, a detection module (e.g. detection module 216) can be used to detect various activities that can affect the user's availability to communicate.

Although embodiments of the present invention will generally be described in terms of automatically identifying preferred communication modes, it may be understood that any other suitable information (e.g., state, icon, and/or message) can be automatically generated by the communications device. For example, in response to detecting that a user is participating in an activity, the communications device can automatically generate a message that is suitable for the activity. In addition, it may be understood that although the present invention will be describing sensor and device options, any other suitable types of automatic options can be used by the communications device to determine the user's preferred communication modes.

In some embodiments, display screen 900 can include “SENSOR” option 902, which the user may turn on or off. In response to the user turning on “SENSOR” option 902, the communications device can be operative to receive categories of data acquired from sensors and can determine if a user is participating in an activity. In some embodiments, the sensors can be located on the device itself or located on a remote object (e.g., Nike+ sensors installed on shoes). In some embodiments, the sensors can communicate with the device via a wired link. In some embodiments, the sensors can communicate wirelessly with the device via a communications network. In some embodiments, the categories of data that can be gathered by the sensors can include location data, environment data, exercise data (e.g., Nike+ data), any other suitable sensor data, or a combination thereof.

In some embodiments, in response to identifying an activity using the sensors, the communications device can identify the preferred communication modes corresponding to the activity. The communications device can identify the preferred communication modes corresponding to an activity by downloading rules that are stored locally, on the device itself (e.g., memory 204), on a local server, on an external source (e.g., a non-local server connected to the internet), or any combination of these. The locally stored information may have been previously configured by the user. Responsive thereto, an appropriate selection of mode indicators can be displayed to the user's contacts.

In some embodiments, if sensors (e.g., GPS and/or triangulation sensors or detectors) detect that a user is in a movie theater, the communications device can identify the preferred communication modes as voicemail and e-mail. In some embodiments, the communications device can connect to the Nike+ sensors installed on the user's shoes. After the communications device has connected to the Nike+ sensors, the communications device can identify that a user is jogging with the Nike+ workout feature. Based on this determination, the communications device can identify telephonic communications as the communication mode.

In some embodiments, the communications device can calculate the number of miles that the user has logged during the current Nike+ workout, and the communications device can display the user's progress to his contacts. Using this information, the user's contacts can determine whether the user's exercise routine has just begun or is almost over.

In some embodiments, display screen 900 can include “DEVICE” option 904, which the user may turn on or off. In response to the user turning on “DEVICE” option 904, the communications device can be operative to receive categories of non-sensor data acquired from the device itself and can determine if a user is participating in an activity. The categories of device data can include usage data, calendar data, news data, any other suitable device data, or any combination thereof.

In some embodiments, the communications device can be operative to receive usage data, which can indicate whether the user is using the phone function on the communications device. For example, if the communications device detects that the user is talking on the phone, a mode indicator representing telephonic communications may not be displayed for the user's contacts. Instead, mode indicators representing e-mail, voicemail, and instant messaging may be displayed.

In some embodiments, the user's communications device can use rules to determine preferred communication modes. For example, the rules can specify the communication modes available for each phone function (e.g., when the user is on the phone, off the phone, or using voicemail). These rules can be the same as or similar to the rules described previously for “SENSOR” option 902.

In some embodiments, the communications device can be operative to receive calendar data acquired from a calendar application stored on the communications device. After receiving the calendar data, the communications device can determine if the user has a currently scheduled calendar activity. If the communications device determines that the user has a currently scheduled calendar activity, the communications device can determine the preferred communication modes associated with the calendar activity. For example, the communications device can determine that the currently scheduled activity is “shopping with Jill at the mall.” The communications device can determine based on the activity that the user is available to talk on the phone but does not have access to e-mail. As a result, the communications device can display mode indicators representing telephonic communications and text messaging.

In some embodiments, the communications device can determine communication modes available for a calendar activity based on tags that were previously set by the user. For example, the user may set a tag indicating that he does not have access to e-mail for a particular calendar activity. In some embodiments, the communications device can determine user availability for a calendar activity based on interpretations (e.g., using natural language processing) of the calendar entry. For example, the communications device can determine that the main purpose of the calendar activity is shopping. The communications device can then look for available communication modes by downloading rules from a remote server or by accessing locally stored information. These rules can specify the communication modes available for different types of calendar events. For example, the communications device may find a rule that indicates that the communication modes available for shopping are telephonic communications and text messaging.

In some embodiments, the communications device can be operative to simultaneously receive data gathered from “SENSOR” option 902 and “DEVICE” option 904. For example, the user can be concurrently using a media playback application (e.g., iPod™ application made available by Apple Inc.) while he is exercising with the Nike+ feature.

If the user selects to use more than one category of data, the data can output conflicting communication modes. For example, using calendar data, the communications device can determine that the preferred communication modes are e-mail and text message. However, using Nike+ data, the communications device can determine that the preferred communication mode is telephonic communications. In some embodiments, the communications device can resolve the conflicts and identify a subset of the preferred communication modes. It may be understood that the subset of the preferred communication modes can include one or more communication modes.

In some embodiments, the conflicts can be resolved using a priority order that ranks the categories of data. For example, exercise data can have a higher rank than calendar data. As a result, the communications device can select telephonic communications as the preferred communication mode. In some embodiments, the conflicts can be resolved using a priority order that ranks of the preferred communication modes. For example, telephonic communications can have a higher rank than e-mail. In some embodiments, the conflicts can be resolved by user selection. For example, the communications device can present the user with all of the preferred communication modes, and the user may select the ones that will be used. In some embodiments, if all of the automatic options are turned off, the communications device can default to manually configured communication modes, manufacturer-selected default communication modes, or whichever communication modes the user's contacts want to use.

Returning to display screen 600, the user may select “CUSTOMIZED INFORMATION” option 604 to customize the display of the user's information for subsets of the user's contacts in contact listings 502 (FIG. 5).

FIG. 10 shows a schematic view of an illustrative display screen for providing customized information in accordance with one embodiment of the invention. Display screen 1000 can include listings 1002, which can list subsets of the user's contacts. Each subset of the user's contacts can be an individual contact or a contact group and can include one or more of the user's contacts in contact listings 502 (FIG. 5).

Listings 1002 can be organized based on certain parameters. In some embodiments, the user's contacts can be separated into four states (e.g., “available,” “away,” “idle,” and “offline”), which can represent the state of the user as displayed to the contacts. For example, a contact listed under the “away” state may see the user's state as “away,” and a contact listed under the “available” state may see the user's state as “available.” It may be understood that the communications device can display the user's contacts in any suitable way. For example, the contacts can be organized alphabetically. As another example, the contacts can be organized by the frequency of communications, where the contacts that the user communicates with the most frequently are placed at the top of listings 1002. As yet another example, the contacts can be separated by communication modes, which can represent the communication modes of the user as displayed to the contacts.

In some embodiments, the user may create a new communication profile for a subset of the user's contacts by selecting “ADD” option 1004. The communication profile can include options for selecting the customized information that is provided to the subset of the user's contacts. For example, the user may create a communications profile for a contact group called “work group” that can include the user's co-workers. The user may also create a communications profile for a contact group called “family group” that can include the user's family members. In some embodiments, the communications device can automatically generate rest-of-contacts group 1006, which can include contacts in contact listings 502 that have not been configured to receive customized information (e.g., the user may not have created a communications profile for these contacts).

In some embodiments, in response to the user selecting “ADD” option 1004, the communications device may provide options for editing the communications profile of a new subset of the user's contacts. In some embodiments, the user may edit the communications profile of an existing subset of the user's contacts by placing highlight region 1008 over a listing in listings 1002. In response to the user selecting a listing, the communications device can provide options for changing the communications profile of an existing subset of the user's contacts.

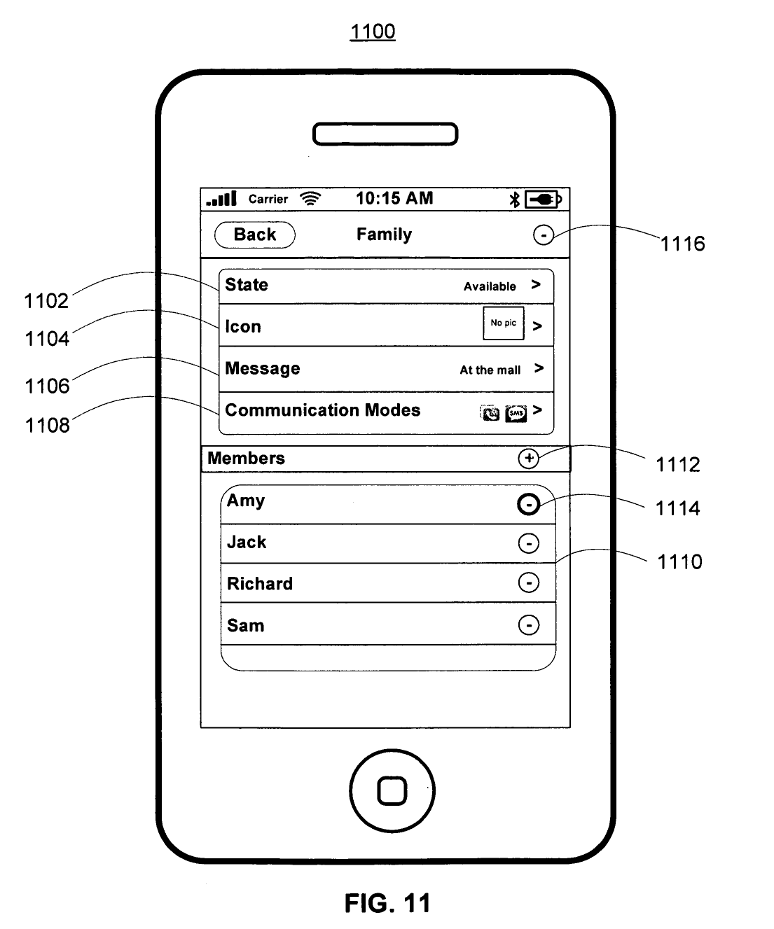

FIG. 11 shows a schematic view of an illustrative display screen for providing options for changing the communications profile of a subset of the user's contacts in accordance with one embodiment of the invention. In some embodiments, display screen 1100 can include “STATE” option 1102, “ICON” option 1104, “MESSAGE” option 1106, and “COMMUNICATION MODES” option 1108, which can be similar to basic information options displayed in display screen 700 (FIG. 7). For example, the user may select “COMMUNICATION MODES” option 1108 to manually or automatically identify the user's preferred communication modes. In response to the user changing the communications profile for the subset of the user's contacts, the communications device can send the customized information for display to the subset of the user's contacts. In some embodiments, the customized information for display can include selectable mode indicators that represent the preferred communication modes. For example, the user can select to display an icon for a first contact and a different icon for a second contact.

In some embodiments, for contact groups, display screen 1100 can include listings 1110, which can list members of the contact group. The user can add new members to the contact group by selecting “ADD” option 1112. In some embodiments, in response to the user selecting “ADD” option 1112, the communications device can provide the user with a list of contacts that are not included in previously created contact groups (e.g., rest of contacts group 1006). In other embodiments, the communications device can provide the user with a list of all contacts, regardless of whether any one of the contacts has already been included in another group.

In some embodiments, the user may delete a member from the contact group by selecting “DELETE” option 1114. In some embodiments, in response to the user selecting “DELETE” option 1114, the communications device can add the deleted contact to rest of contacts group 1006. In some embodiments, the user may delete the contact or contact group communications profile by selecting “DELETE” option 1116. In some embodiments, in response to the user selecting “DELETE” option 1116, the communications device may add the deleted contact or contacts to rest of contacts group 1006.

In some embodiments, the communications device can store a subset of the user's contacts in memory (e.g. memory 204) and can allow the user to share the subset of the user's contacts among multiple applications. It may be understood that the multiple applications can include two or more applications. For example, the communications device can be configured to add newly created contact groups to the user's address book. If the user wants to compose an e-mail to a group of people, instead of locating each contact individually, the user may be able to find the contact group listed in the address book.

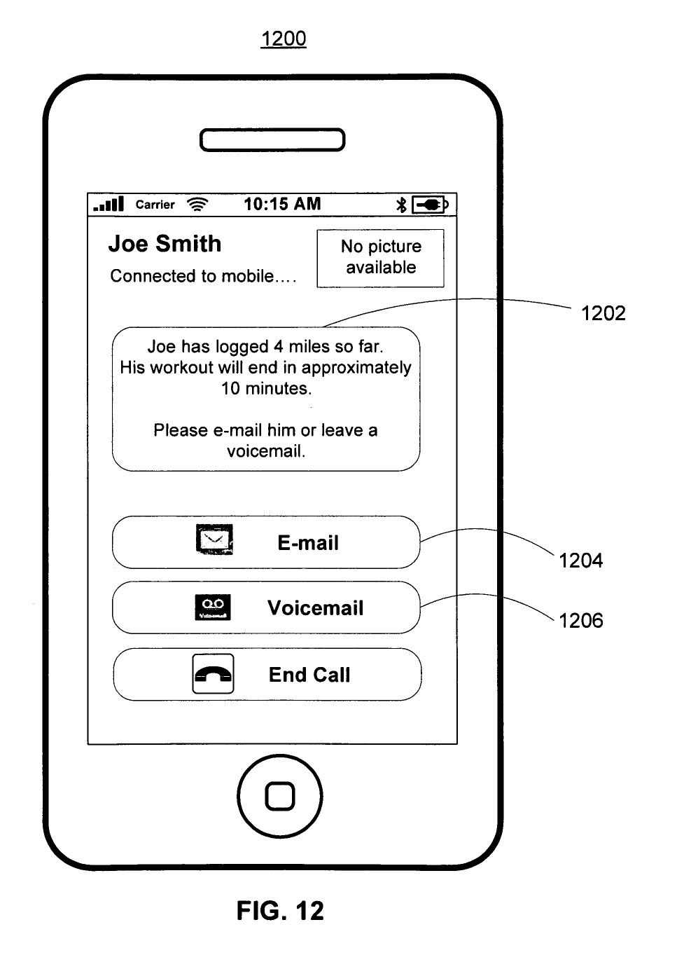

FIG. 12 shows a schematic view of an illustrative display screen for displaying a message with recommendations of preferred communication modes in accordance with one embodiment of the invention. Although FIG. 12 particularly shows messages that can be sent in response to an incoming telephonic communications request from a contact, similar messages can be sent for any other suitable type of incoming communications request (e.g., voicemail, e-mail, text message, and instant message). In some embodiments, the contact may be using a device, such as device 304 (FIG. 3), with similar functionalities as the communications device. In response to the contact calling the user using a phone application on the contact's device, the user's communications device may check to see the preferred communication modes that have been configured for the contact. For example, the communications device may have automatically identified the preferred communication modes based on identifying that the user is participating in an activity. As another example, the user may have configured a communications profile for the contact identifying the preferred communication modes. In response to a positive determination (e.g., it is determined that the contact may communicate with the user through telephonic communications), the communications device can notify the user of the telephonic communications. In response to a negative determination (e.g., it is determined that the contact may not communicate with the user through telephonic communications), the communications device may not notify the user of the telephonic communications and may instead send information back to the contact's device. The information can identify one or more preferred communication modes that are currently available to the contact.

In some embodiments, if the communications device can identify that the user is participating in an activity based on one or more categories of data, the communications device can send a message back to the contact's device that includes real-time information about the activity. For example, if the user's communications device is configured to receive exercise data from Nike+ sensors, the communications device can send a message that includes the number of miles that the user has logged so far. The message can also include the approximate time needed to complete the workout based on previously defined workout goals, which can be stored locally, on the device itself (e.g., memory 204), on a local server, on an external source (e.g., a non-local server connected to the internet), or any combination of these.

When the contact's device receives the information from the user's communications device, the contact's device can display the information to the contact. Display screen 1200 can include message 1202, which can be the message received from the user's communications device. In some embodiments, display screen 1200 can include “E-MAIL” option 1204 and “VOICEMAIL” option 1206, which can be selectable graphic images representing the preferred communication modes. In response to the contact selecting “E-MAIL” option 1204, the contact's device can allow the contact to compose an e-mail to the user. The contact's device can end the telephonic communications once the contact leaves the phone application. In some embodiments, in response to the contact selecting “VOICEMAIL” option 1206, the contact's device can allow the contact to leave the user a voicemail.

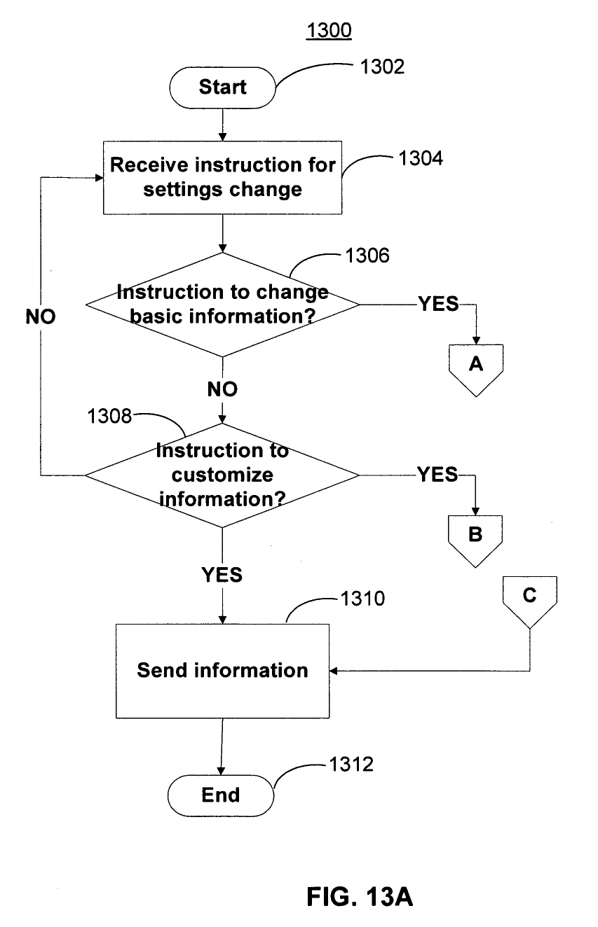

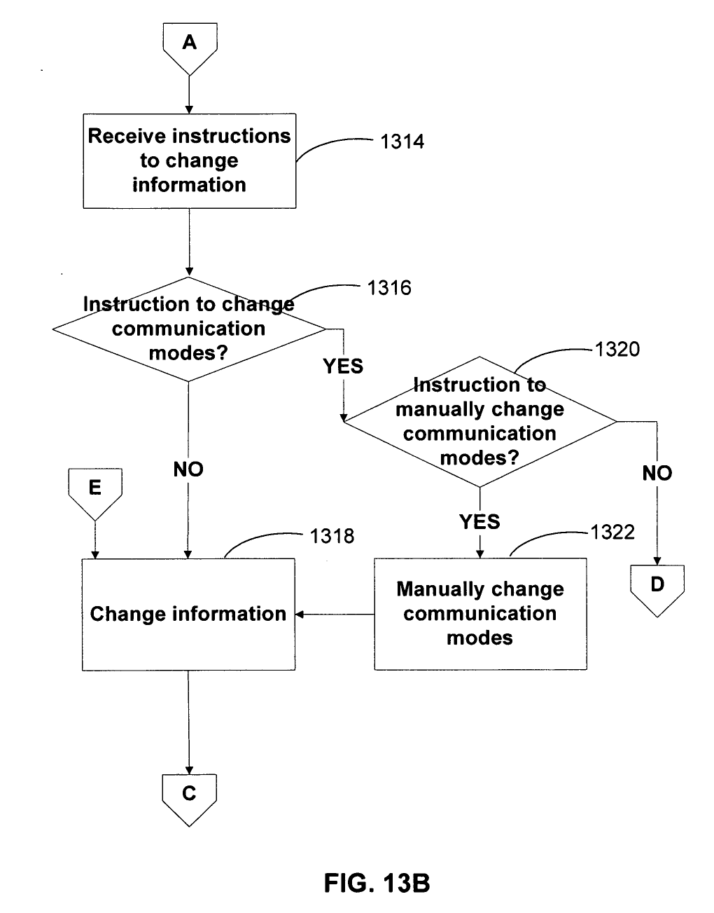

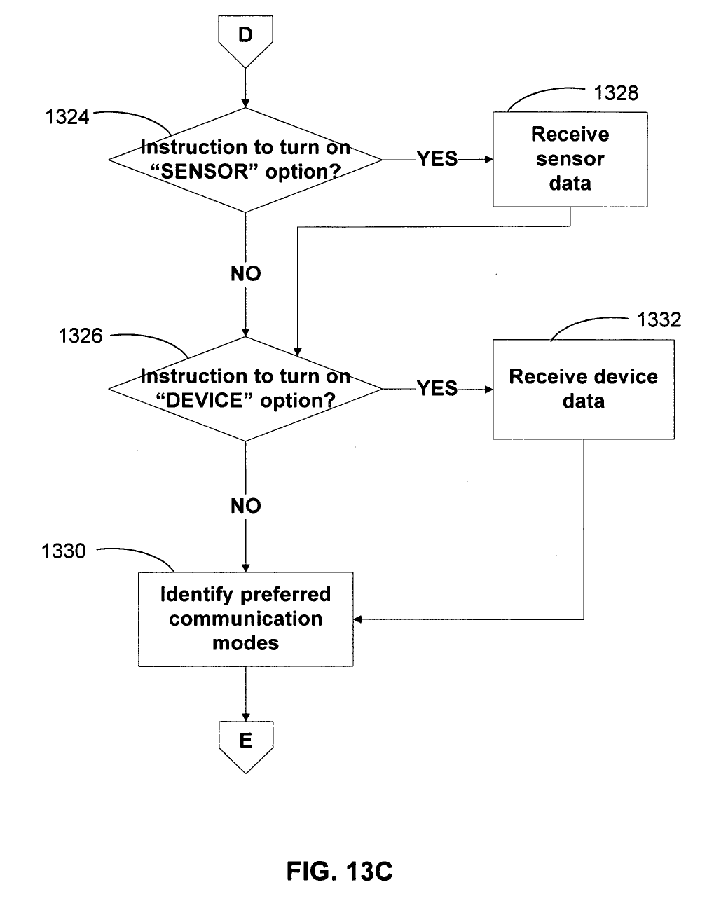

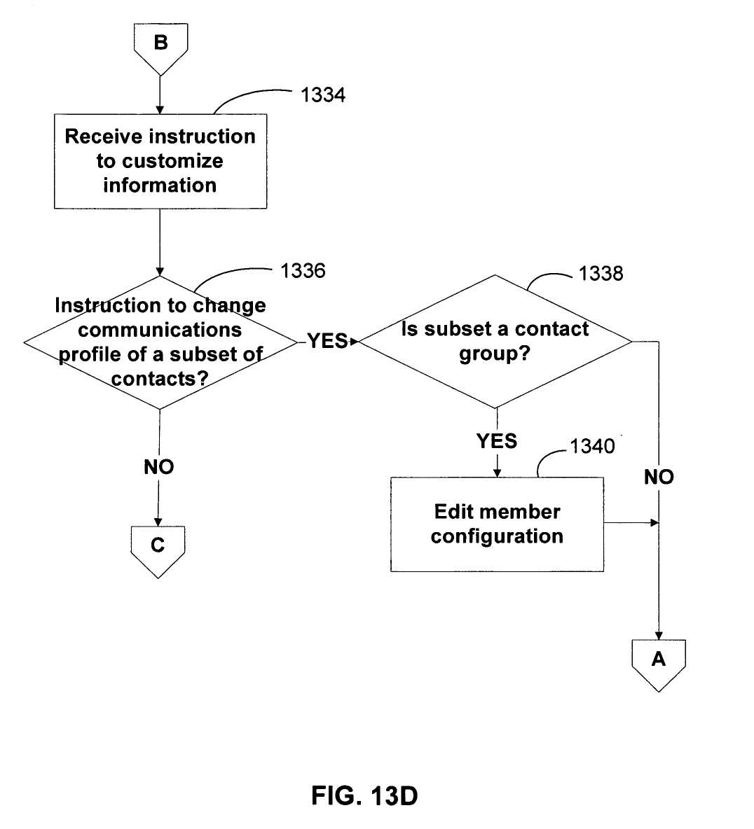

FIGS. 13A-13D show flowcharts of an illustrative process for changing settings in accordance with one embodiment of the invention. Process 1300 starts at step 1302. At step 1304, a communications device can receive an instruction for settings change. For example, the communications device can receive the instruction for settings change when a user selects “SETTINGS” option 520 (FIG. 5). At step 1306, the communications device may determine whether the user provided an instruction to change basic information. For example, the user may select “BASIC INFORMATION” option 602 (FIG. 6) to configure information that can be globally displayed to the user's contacts.

If, at step 1306, the communications device determines that an instruction to change basic information has not been received, process 1300 moves to step 1308. At step 1308, the communications device may determine whether the user provided an instruction to customize information for a subset of the user's contacts. For example, the user may select “CUSTOMIZED INFORMATION” option 604 to customize the display of information for a subset of the user's contacts.

If, at step 1308, the communications device determines that an instruction to customize information has not been received, process 1300 moves to step 1310. At step 1310, the communications device can send the user's information for display to the user's contacts. Process 1300 ends at step 1312. For example, the user may select “DONE” option 606 to return to display screen 500 (FIG. 5).

If, at step 1306, the communications device instead determines that an instruction to change basic information has been received, process 1300 moves to step 1314. At step 1314, the communications device can receive instructions to change the user's information. For example, the user may select to change state option 702, icon option 704, message option 706, and/or communication modes option 708 (FIG. 7). At step 1316, the communications device may determine whether the user provided an instruction to change communication modes. If, at step 1316, the instant messaging device determines that an instruction to change communication modes has not been received, process 1300 moves to step 1318. For example, the user may select “DONE” option 710 (FIG. 7) to return to display screen 600 (FIG. 6). At step 1318, the communications device can change the user's information based on the received instructions. Process 1300 then moves to step 1310, as described above.

If, at step 1316, the communications device instead determines that an instruction to change communication modes has been received, process 1300 moves to step 1320. At step 1320, the communications device can determine whether the user provided an instruction to manually change communication modes. For example, in response to the user selecting manual option 802 (FIG. 8), the communications device can allow the user to select any combination of mode indicators representing communication modes (e.g., telephonic communications, voicemails, text messages, instant messages, and e-mails).

If, at step 1320, the communications device determines that an instruction to manually change communication modes has been received, process 1300 moves to step 1322. At step 1322, the communications device can manually change the communication modes selected by the user. Process 1300 then moves back to step 1318, as described above. For example, the user may select “DONE” option 806 (FIG. 8) to return display screen 700 (FIG. 7). If, at step 1320, the communications device instead determines that an instruction to manually change communication modes has not been received, process 1300 moves to step 1324. For example, the user may select automatic option 804 (FIG. 8), which can allow the communications device to determine if a user is participating in an activity. In response to determining that the user is participating in an activity, the communications device can automatically change communication modes.

At step 1324, the communications device can determine whether an instruction to turn on a “SENSOR” option has been received. If, at step 1324, the communications device determines that the instruction to turn on the “SENSOR” option has not been received, process 1300 moves to step 1326. For example, the user may select to turn off “SENSOR” option 902 (FIG. 9). If, at step 1324, the communications device instead determines that an instruction to turn on the “SENSOR” option has been received, process 1300 moves to step 1328. At step 1328, the communications device can receive sensor data. For example, the sensor data can include location data, environment data, Nike+ data, or any combination thereof. Process 1300 then moves to step 1326.

At step 1326, the communications device can determine whether an instruction to turn on a “DEVICE” option has been received. If at step 1326, the communications device determines the instruction to turn on a “DEVICE” option has not been received, process 1300 moves to step 1330. For example, the user may select to turn off “DEVICE” option 904 (FIG. 9). If, at step 1326, the communications device instead determines that an instruction to turn on the “DEVICE” option has been received, process 1300 moves to step 1332. At step 1332, the communications device can receive device data. For example, device data can include usage data, calendar data, news data, or any combination thereof. Process 1300 then moves to step 1330. For example, the user may select “BACK” option 910 (FIG. 9) to return to display screen 800 (FIG. 8).

At step 1330, the communications device can identify the preferred communication modes for each category of data that is collected. In some embodiments, if there are conflicts among the preferred communication modes, the communications device can identify a subset of the preferred communication modes based on certain criteria. In some embodiments, conflicts can be resolved based on user selection. In some embodiments, conflicts can be resolved based on a priority order that ranks the categories of data. In some embodiments, conflicts can be resolved based on a priority order that ranks the preferred communication modes. After determining the communication modes, process 1300 then moves to step 1318 to change the user's information, as described previously. For example, the user may select “BACK” option 910 (FIG. 9) and “DONE” option 806 (FIG. 8) to return to display screen 700 (FIG. 7).

Referring back to FIG. 13A, if, at step 1308, the communications device instead determines that an instruction to change customized information has been received, process 1300 moves to step 1334. At step 1334, the communications device can receive instruction to customize information for a subset of the user's contacts. At step 1336, the communications device can determine whether an instruction to change the communications profile of a subset of the user's contacts (e.g., an individual contact or contact group) has been received. For example, the user may select to change the information that is displayed to an individual contact or contact group. As another example, the user may add, change, or delete members of a contact group. If, at step 1336, the communications device determines that an instruction to change the communications profile of a subset of the user's contacts has not been received, process 1300 moves to step 1310, as described above. For example, the user may have selected “BACK” option 1010 (FIG. 10) to return to display screen 600 (FIG. 6).

If, at step 1336, the communications device instead determines that an instruction to change the communications profile of a subset of the user's contacts has been received, process 1300 moves to step 1338. At step 1338, the communications device can determine whether the subset of the user's contacts is a contact group. If, at step 1338, the communications device determines that the subset of the user's contacts is not a contact group, process 1300 moves to step 1314, where the communications device can receive instructions to change information.

If, at step 1338, the communications device instead determines that the subset of the user's contacts is a contact group, process 1300 may proceed to step 1340. At step 1340, the user may edit the member configuration of the contact group. For example, the user may add or delete members by selecting add option 1112 or delete option 1114 (FIG. 11). After editing the member configuration of the contact group, process 1300 moves to step 1314, as described previously.

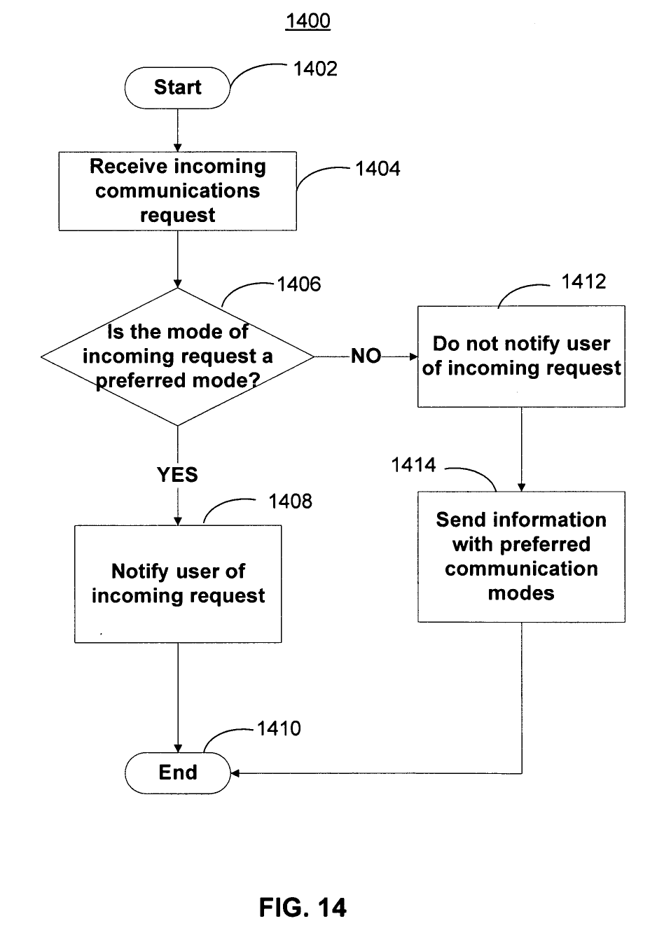

FIG. 14 shows a flowchart of an illustrative process for processing incoming communications requests in accordance with one embodiment of the invention. Process 1400 starts at step 1402. At step 1404, a communications device, such as communications device 200 (FIG. 2), can receive an incoming communications request. For example, a contact can use a device similar to the communications device to send a telephonic communications to the user.

At step 1406, the communications device can determine whether the communication mode of the incoming request is preferred. For example, the communications device can check to see whether the communication modes that have been configured for the contact includes telephonic communications. If, at step 1406, the communications device determines that the communication mode of the incoming request is preferred, process 1400 moves to step 1408. At step 1408, the communications device can notify the user of the incoming request. Process 1400 then ends at step 1410.

If, at step 1406, the communications device instead determines that the communication mode of the incoming request is not preferred, process 1400 moves to step 1412. At step 1412, the communications device may not notify the user of the incoming request. For example, the communications device can set the ring tone of the communications device to silent. At step 1414, the communications device can send information identifying the preferred communication modes back to the contact's device. In some embodiments, if the user's communications device can identify that the user is participating in an activity, the communications device can send a message, such as message 1202 (FIG. 12) back to the contact's device. The message can include real-time information about the user's activity. Process 1400 then ends at step 1410.

The above described embodiments of the present invention are presented for purposes of illustration and not of limitation, and the present invention is limited only by the claims which follow.

What is claimed is:

1. A method of providing communication modes of a user comprising:
identifying an activity in which the user is participating based on one or more categories of data;
identifying one or more preferred communication modes for the user based on the activity;
establishing a communications channel with a contact's device; and
notifying the contact's device of at least one preferred communication mode via the communications channel.

2. The method of claim 1 wherein the identifying an activity comprises identifying the activity based on sensor data.

3. The method of claim 2 wherein the sensor data comprises exercise data, location data, environment data, or any combination thereof.

4. The method of claim 1 wherein the identifying comprises identifying the activity based on device data.

5. The method of claim 4 wherein the device data comprises calendar data, news data, usage data, or any combination thereof.

6. The method of claim 1 further comprising identifying a subset of the preferred communication modes based on a priority order, wherein notifying the contact's device of at least one preferred communication mode comprises notifying the contact's device of the subset of the preferred communication modes.

7. The method of claim 6 wherein the priority order is based on a rank of the preferred communication modes.

8. The method of claim 6 wherein the priority order is based on a rank of the categories of data.

9. The method of claim 1 further comprising identifying a subset of the preferred communication modes based on user selection, wherein notifying the contact's device of at least one preferred communication mode comprises notifying the contact's device of the subset of the preferred communication modes.

10. Apparatus for providing customized information to at least a subset of a user's contacts comprising:
memory for storing a communications profile of the user's contacts, wherein the communications profile includes options for selecting the customized information that is provided to the user's contacts;
an input for accepting user commands;
a processor configured to:
accept an input user command to change the communications profile for the subset of the user's contacts; and
select the customized information based on the options; and
communications circuitry configured to send the customized information for display to the subset of the user's contacts.

11. The apparatus of claim 10 wherein the customized information comprises the user's state, icon, message, communication modes, or any combination thereof.

12. The apparatus of claim 10 wherein the processor is configured to determine communication modes for sending the customized information to the subset of the user's contacts based on whether the user is participating in an activity.

13. The apparatus of claim 10 wherein the processor, based on inputs from the user, is configured to add and delete at least one contact from the subset of the user's contacts.

14. The apparatus of claim 10 wherein the processor is configured to create a rest-of-contacts group, wherein the rest-of-contacts group comprises the user's contacts that have not been configured to receive customized information.

15. The apparatus of claim 14 wherein the processor is configured to add a contact deleted from the subset of the user's contacts to the rest-of-contacts group.

16. The apparatus of claim 10 wherein the customized information for display comprises communication modes, wherein the communication modes are represented by selectable mode indicators.

17. The apparatus of claim 10 wherein the processor enables the user to share the subset of the user's contacts among multiple applications.

18. A communications device comprising:
communications circuitry for receiving an incoming communications request in a first communication mode from a contact device; and
a processor configured to:
identify an activity in which the user is participating based on one or more categories of data;
identify one or more preferred communication modes for the user based on the activity;
determine whether the first communication mode is a preferred communication mode;
in response to a negative determination, send information identifying one or more preferred communication modes to the contact device; and
in response to a positive determination, notify a user of the incoming communications request.

19. The communications device of claim 18 wherein the data comprises sensor data, device data, or a combination thereof.

20. The communications device of claim 18 wherein the first processor sends a message to the contact device, wherein the message comprises real-time information about the activity.

21. A first communications device comprising:
communications circuitry for receiving information from a second communications device, wherein the information relates to one or more preferred communication modes associated with an activity being performed by a user of the second communications device; and
a processor configured to enable a user to send a communications request to the second communications device using one of the one or more preferred communication modes.

22. The communications system of claim 21 wherein the processor is configured to cause the display to provide one or more selectable graphic images representing the one or more preferred communication modes.

23. The communications system of claim 22 wherein the processor is configured to enable the user to select one of the one or more graphic images to send the communications request.
